(19) United States
(12) Patent Application Publication
(10) Pub. No.: US 2013/0263011 A1
(43) Pub. Date: Oct. 3, 2013

(54) CONTROL OF COMPUTING DEVICES AND USER INTERFACES

(71) Applicant: Apptui Inc., Stoney Creek, CA (US)

(72) Inventor: Daniel Matthew Clark, Stoney Creek (CA)

(73) Assignee: Apptui Inc., Stoney Creek, CA (US)

(21) Appl. No.: 13/899,959

(22) Filed: May 22, 2013

Related U.S. Application Data
(62) Division of application No. 13/226,447, filed on Sep. 6, 2011.
(60) Provisional application No. 61/380,649, filed on Sep. 7, 2010.
(60) Provisional application No. 61/415,204, filed on Nov. 18, 2010.

(51) Int. Cl. G06F 3/0484

(52) U.S. Cl. CPC G06F 3/0484
USPC 715/745

(57) ABSTRACT

A controlling computing device connected to an interconnecting network can control specified functionality of a controllable computing device connected to the interconnecting network by using at least one unique identifier to establish a connection between the controllable computing device and the controlling computing device, with a user interface being provided to the controlling computing device. User interfaces enabling the controlling computing device to control the specified functionality of the controllable computing device may be created and modified by receiving control input comprising associations between actions on the controlling computing device and commands for controlling the specified functionality of the controllable computing device, and storing the actions, associations and commands as part of the user interface. User interfaces may be made available by storing a library of predefined user interfaces and, responsive to a request for a particular one of the user interfaces, transmitting that particular user interface to the requestor.

### CROSS-REFERENCE TO RELATED APPLICATIONS

This application is a divisional of U.S. patent application Ser. No. 13/226,447 filed on Sep. 6, 2011, which claims priority to U.S. Provisional Patent Application No. 61/380,649 filed on Sep. 7, 2010 and to U.S. Provisional Patent Application No. 61/415,204 filed on Nov. 18, 2010, the teachings of each of which are hereby incorporated by reference.

### FIELD OF INVENTION

The present invention relates to control of computing devices and user interfaces, and more particularly to control of one computing device by another computing device and to customization and socialization of user interfaces.

### BACKGROUND OF THE INVENTION

Various methods are known for enabling a first network-connected computing device to control a second network-connected computing device. For example, in Virtual Network Computing the RFB protocol is used to send keyboard and mouse inputs from the first computing device to the second computing device and to return screen graphics from the second computing device to the first computing device.

U.S. Patent Application Publication No. 2009/0144629 in the name of Ferlitsch et al. describes the use of a mobile device such as a smartphone to control a networked multi-function peripheral (“MFP”) such as a combined printer/scanner. Responsive to a request from the mobile device, a controlling application is loaded and executed for controlling the MFP, and a user interface is provided to the mobile device, which enables the mobile device to send control commands to the controlling application for controlling the MFP.

U.S. Pat. No. 7,707,606 and U.S. Patent Application Publication No. 2010/0191833 in the name of Hofrichter et al. teach a home network system that provides for interoperability of the networked devices such as televisions, video players, video cameras and the like. A gateway device such as a personal computer with Internet access communicates with the various devices to identify compatible applications, downloads the compatible applications from remote servers (e.g. the Internet) and provides a centralized GUI for enabling a user to select and execute a given application for controlling the devices.

U.S. Pat. No. 7,783,702 to Liu et al. teaches a system and method for using a mobile phone to control a computing device such as a personal computer. The phone is connected wirelessly to the computing device, for example via Bluetooth, Wi-Fi, GPRS or CDMA1x. Interaction engines are installed on both the phone and the computing device to enable them to communicate with one another and to enable the mobile phone to control the computer.

Although the above references teach systems and methods for enabling one computing device to control another computing device, there remains a need for efficient systems and methods that enable a controlling computing device to identify computing devices that are available to be controlled, without the controlling computing device having to connect to those computing devices or to their local networks in order to identify them.

In addition, while it is known for software programs to enable their user interfaces to be customized on a local computing device, there remains a need for systems and methods that facilitate the creation, modification and sharing of user interfaces.

### SUMMARY OF THE INVENTION

The present invention enables a computing device, such as an Internet-capable smartphone, to remotely control specified functionality of another computing device connected to the same interconnecting network. For example, a smartphone could be used to control a game console or a public video display system. The invention also enables a user community to develop, edit and share customized user interfaces for software applications and specified content.

In one aspect, the present invention is directed to a method for enabling a controlling computing device connected to an interconnecting network to control a controllable computing device connected to the interconnecting network. The method comprises receiving at a connection management server, from the controlling computing device, at least one unique identifier for the controllable computing device. The connection management server uses the unique identifier to facilitate a connection between the controllable computing device and the controlling computing device via the interconnecting network. The method may further comprise the connection management server delivering to the controlling computing device a user interface for controlling the controllable computing device. The connection may be a socket connection via the Internet, and the at least one unique identifier may be one or more of a URL, an alphanumeric code, a WiFi beacon, a QR code, a bar code and an e-mail address.

In another aspect, the present invention is directed to a method for enabling a controlling computing device connected to an interconnecting network to control specified functionality of a controllable computing device connected to the interconnecting network. The method comprises presenting, at the controllable computing device, at least one unique identifier for establishing a connection between the controllable computing device and the controlling computing device. The unique identifier is presented independently of any user interaction with the controllable computing device. The method further comprises receiving, at the controllable computing device, a connection request from the controlling computing device, with the connection request being based on the unique identifier. In response to the connection request, the method establishes a connection between the controllable computing device and the controlling computing device via the interconnecting network using the unique identifier, and the controllable computing device identifies and delivers to the controlling computing device a user interface for controlling the specified functionality of the controllable computing device. The at least one unique identifier may be at least one of a URL, an alphanumeric code, a WiFi beacon, a QR code, a bar code and an e-mail address. The connection may be a socket connection via the Internet, and the unique identifier may describe a URL from a web connection to the socket connection.

In one embodiment, the user interface is limited to a predefined set of commands associated with the specified functionality. The specified functionality may be an application or a file, or both.

In a further aspect, the present invention is directed to a method for defining a user interface for controlling, from a controlling computing device connected to a network, specified functionality of a controllable computing device connected to the network. The method comprises receiving control input comprising associations between actions on the controlling computing device and commands for controlling the specified functionality of the controllable computing device, and storing the actions, associations and commands as part of the user interface. In a preferred embodiment, the controlling computing device is a touch-screen device and the actions on the controlling computing device comprise actuation of touch-actuable widgets, and the method further comprises receiving positional input defining a positional layout of the touch-actuable widgets on a screen of the touch-screen device and storing the positional layout as part of the user interface.

In one embodiment, the user interface is a modified user interface and the step of receiving control input associating actions on the controlling computing device with commands associated with the specified functionality of the controllable computing device comprises modification of an original user interface. In another embodiment, the user interface is a new user interface.

In one embodiment, the user interface is stored on a server accessible by a plurality of parties and the user interface is made available to at least some of the plurality of parties.

In a still further aspect, the present invention is directed to a method of making user interfaces available. The method comprises storing a library of predefined user interfaces and, responsive to a request for a particular one of the user interfaces, transmitting that particular user interface to the requestor. The method may further comprise receiving additional user interfaces from third parties and adding the additional user interfaces to the library. Preferably, before adding the additional user interfaces to the library, the method validates the additional user interfaces and adds the additional user interfaces to the library only in response to successful validation of the additional user interfaces.

In one embodiment, the user interfaces enable control, from a controlling computing device connected to an interconnecting network, of specified functionality of a controllable computing device connected to the interconnecting network, and the particular user interface is transmitted to the controlling computing device in response to the request for the particular user interface.

The user interfaces may be associated with different software applications, and may include a subset of different user interfaces associated with a single software application.

The method may further comprise receiving a modified user interface comprising a modified version of the particular user interface transmitted in response to the request and adding the modified user interface to the plurality of predefined user interfaces.

In other aspects, the present invention is directed to computing devices and computer program products for implementing the above methods.

### BRIEF DESCRIPTION OF THE DRAWINGS

These and other features of the invention will become more apparent from the following description in which reference is made to the appended drawings wherein:

FIG. 1 shows schematically a first system for enabling a controlling computing device connected to an interconnecting network to control specified functionality of a controllable computing device connected to the interconnecting network, according to an aspect of the present invention;

FIG. 2 is a flow chart showing a first exemplary method for enabling a controlling computing device connected to an interconnecting network to control a controllable computing device connected to the interconnecting network;

FIGS. 3A and 3B show schematically a first particular exemplary implementation of the system of FIG. 1;

FIG. 3C and FIG. 3D show schematically a second particular exemplary implementation of the system of FIG. 1;

FIG. 3E and FIG. 3F show schematically a third particular exemplary implementation of the system of FIG. 1;

FIG. 3G and FIG. 3H show schematically a first exemplary implementation of the system of FIG. 1 using WiFi beacons as unique identifiers;

FIGS. 3I and 3J show schematically a second exemplary implementation of the system of FIG. 1 using WiFi beacons as unique identifiers;

FIG. 4 shows schematically a first particular exemplary implementation of a second system for enabling a controlling computing device connected to an interconnecting network to control a controllable computing device connected to the interconnecting network, according to an aspect of the present invention;

FIG. 4A shows schematically a second particular exemplary implementation of the second system for enabling a controlling computing device connected to an interconnecting network to control a controllable computing device connected to the interconnecting network, according to an aspect of the present invention;

FIG. 4B shows schematically a third particular exemplary implementation of the second system for enabling a controlling computing device connected to an interconnecting network to control a controllable computing device connected to the interconnecting network, according to an aspect of the present invention;

FIG. 5 is a flow chart showing a second exemplary method for enabling a controlling computing device connected to an interconnecting network to control specified functionality of a controllable computing device connected to the interconnecting network, according to an aspect of the present invention;

FIG. 6 shows schematically an exemplary system for creation, modification and distribution of user interfaces, according to an aspect of the present invention;

FIG. 7 is a flow chart showing an exemplary method for defining a user interface for controlling, from a controlling computing device connected to a network, specified functionality of a controllable computing device connected to the network, according to an aspect of the present invention;

FIG. 8 is a flow chart showing an exemplary method for making user interfaces available, according to an aspect of the present invention;

FIG. 9 is a schematic representation of an exemplary smartphone, which may be used in implementing aspects of the present invention; and

FIG. 10 is a schematic representation of an exemplary computer system, which may be used in implementing aspects of the present invention.

### DETAILED DESCRIPTION

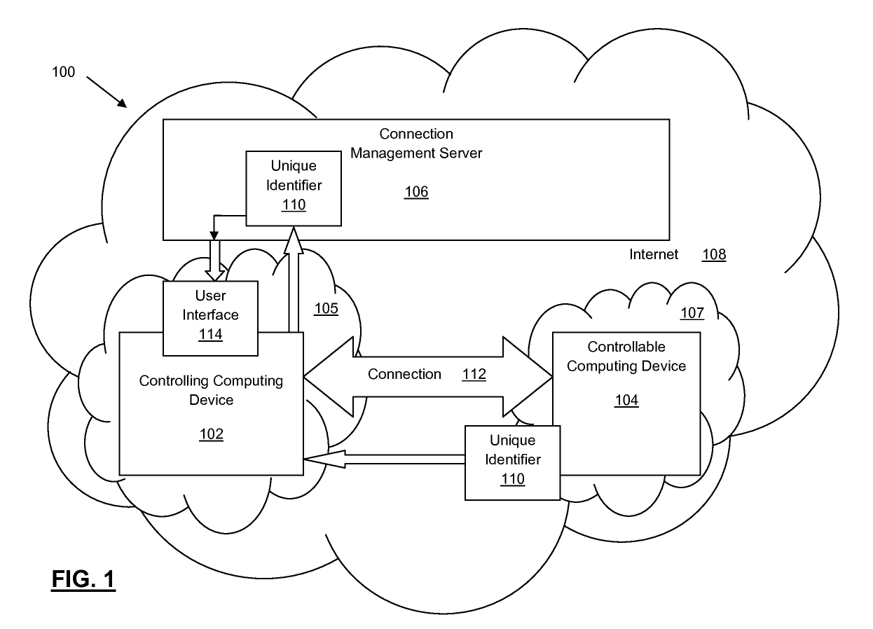

Referring now to FIG. 1, an exemplary embodiment of a system for enabling a controlling computing device connected to an interconnecting network to control a controllable computing device connected to the interconnecting network is shown generally at 100. The system 100 comprises a controlling computing device 102, a controllable computing device 104, and a connection management server 106. The controlling computing device 102 is connected to a first local network 105 and the controllable computing device 104 is connected to a second local network 107; the controlling computing device 102 and the controllable computing device 104 are not directly connected to the same local network and are not directly connected to each other. The controlling computing device 102 is connected, via the first local network 105, to an interconnecting network 108, and the controllable computing device 104 is also connected, via the second local network 107, to the interconnecting network 108. The connection management server 106 is also connected to the interconnecting network 108. As used herein, the term “interconnecting network” refers to a network that enables communication between remote computing devices that are not directly connected to one another and are not connected to one another via a local network. An interconnecting network is typically a network of networks, and in the illustrated embodiment the interconnecting network 108 is the Internet.

The controlling computing device 102 may be any suitable device, such as a desktop computer, laptop computer, network-capable tablet computer, network-capable smartphone, or the like. Preferably, the controlling computing device 102 is a network-capable tablet computer or network-capable smartphone having a touch-screen display that can receive tactile input from a user. Connection of the controlling computing device 102, controllable computing device 104 and connection management server 106 to their respective local networks 105, 107 and thereby to the Internet 108 may be either wired or wireless, and in the case where the controlling computing device 102 is a network-capable tablet computer or network-capable smartphone, the connection between the controlling computing device 102 and the interconnecting network 108 is preferably wireless, for example by way of a WiFi connection or a 3G or 4G connection.

At least one unique identifier 110 is presented at the controllable computing device 104. Typically, the unique identifier 110 is assigned by the connection management server 106, and typically communicated from the connection management server 106 to the controllable computing device 104 via the Internet 108. As explained in greater detail below, the connection management server 106 uses the unique identifier 110 to facilitate a connection 112 between the controllable computing device 104 and the controlling computing device 102. The unique identifier 110 may be, for example, a URL an alphanumeric code, a WiFi beacon, a QR code, a bar code or an e-mail address, and is used to uniquely identify the controlled device 104. The unique identifier 110 is presented independently of any user interaction with the controllable computing device 104, that is, a user who wishes to control the controllable computing device 104 does not have to do anything to cause the unique identifier 110 to be presented. For example, where the unique identifier 110 is an alphanumeric code, a QR code, a bar code or an e-mail address, the unique identifier 110 may be presented on a display of the controllable computing device 104, or may be presented at a location in close proximity to the controllable computing device 104, such as on a wall adjacent to a display thereof, and may be a non-electronic display. Where the unique identifier 110 is a WiFi beacon, the WiFi beacon will broadcast without any action by the user who seeks to control the controllable computing device 104.

The unique identifier 110 is received by the controlling computing device 102, and then transmitted by the controlling computing device 102 to the connection management server 106. Where the unique identifier 110 is an alphanumeric code or e-mail address, it may be input into the controlling computing device 102 manually by way of a keyboard or touch-screen display. Where the unique identifier 110 is a QR code or a bar code, it may be scanned using a camera (built-in or peripheral) on the controlling computing device 102. In addition, where the unique identifier 110 is an alphanumeric code or e-mail address, it may be scanned using a camera and then interpreted using optical character recognition (OCR) software. Where the unique identifier 110 is a WiFi beacon, the controlling computing device 102 will automatically receive the WiFi beacon as long as the controlling computing device 102 has suitable wireless network capability.

When the connection management server 106 receives the unique identifier 110 from the controlling computing device 102, the connection management server 106 then uses the unique identifier 110 to facilitate a connection 112 between the controllable computing device 104 and the controlling computing device 102. For example, the connection management server 106 may use the unique identifier 110 to obtain the required network information about the controllable computing device 104 from a lookup table. Although the connection 112 between the controllable computing device 104 and the controlling computing device 102 may pass through the connection management server 106, preferably the connection 112 between the controllable computing device 104 and the controlling computing device 102 is one which, once established, bypasses the connection management server 106. In a particularly preferred embodiment, the connection 112 between the controllable computing device 104 and the controlling computing device 102 is a socket connection via the Internet. The socket connection may be, for example, a web socket connection, a scripted socket connection such as a jsocket, or other suitable socket connection. The connection 112 may use suitable encryption algorithms.

Generally speaking, the term “socket” refers to an endpoint of a bidirectional inter-process communication flow across an Internet Protocol-based computer network, such as the Internet 108, and a socket connection refers to such a communication flow. With an Internet socket, an application programming interface (API) for the TCP/IP protocol stack is provided, usually by the operating system, as a mechanism for delivering incoming data packets to the appropriate application process or thread, based on a combination of local and remote IP addresses and port numbers. Each socket is mapped by the operating system to a communicating application process or thread. A socket address is the combination of an IP address (the location of the computer) and a port (which is mapped to the application program process) into a single identity. A web socket (or “WebSocket”) is a technology providing for bi-directional, full-duplex communications channels over a single Transmission Control Protocol (TCP) socket, and while designed to be implemented in web browsers and web servers, can be used by any client or server application.

In addition to facilitating the connection 112 between the controllable computing device 104 and the controlling computing device 102, the connection management server 106 also uses the unique identifier 110 to identify and deliver to the controlling computing device 102 a user interface 114 for controlling the controllable computing device 104. The connection management server 106 may deliver the user interface 114 either before or after facilitating the connection 112 between the controllable computing device 104 and the controlling computing device 102, but preferably does so after facilitating the connection 112. In an alternative embodiment, the user interface 114 may be sent to the controlling computing device 102 by the controllable computing device 104, rather than the connection management server 106, after the connection 112 between the controllable computing device 104 and the controlling computing device 102 has been established. The user interface 114 will typically be displayed on a screen of the controlling computing device 102, for example to receive input commands from a touch-screen display, and may also include audio features such as audio output and microphone input (e.g. voice commands) and hardware input devices such as keys or buttons. Optionally, the user interface 114 may be stored on the controlling computing device 102 for later reuse.

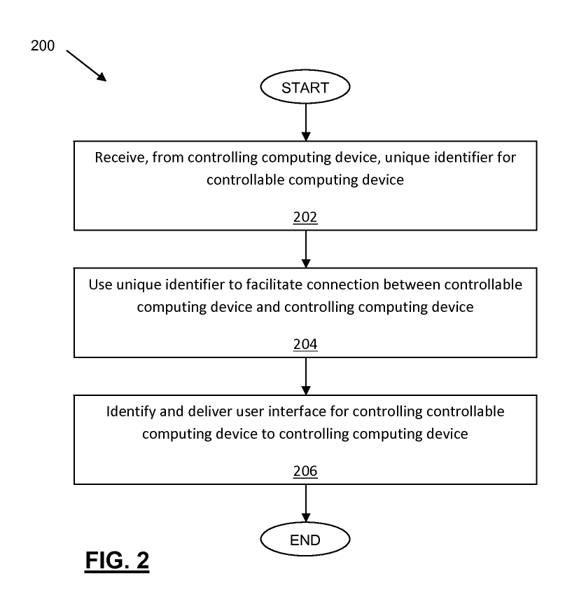

Now referring to FIG. 2, an exemplary method for enabling a controlling computing device (e.g. controlling computing device 102) connected to an interconnecting network (e.g. the Internet 108) to control a controllable computing device (e.g. controllable computing device 104) is shown generally at 200. The method 200 may be carried out by a connection management server (e.g. connection management server 106).

At step 202, the connection management server receives, from the controlling computing device, a unique identifier for the controllable computing device, and at step 204 the connection management server uses the unique identifier to facilitate a connection between the controllable computing device and the controlling computing device. At step 206, which may be performed either before or after step 204, the connection management server uses the unique identifier to identify a user interface for controlling the controllable computing device and delivers the user interface to the controlling computing device.

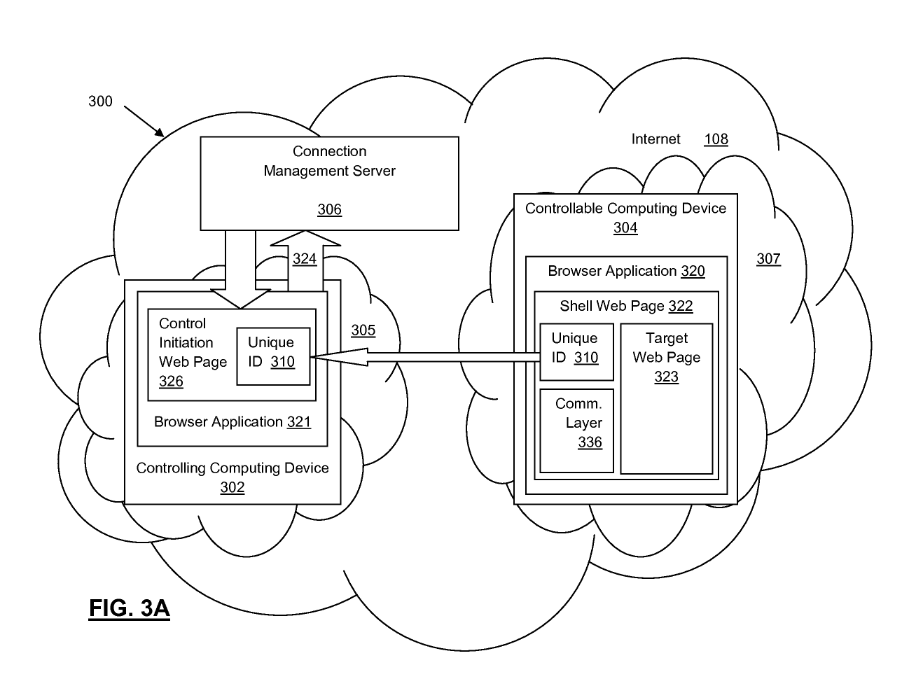

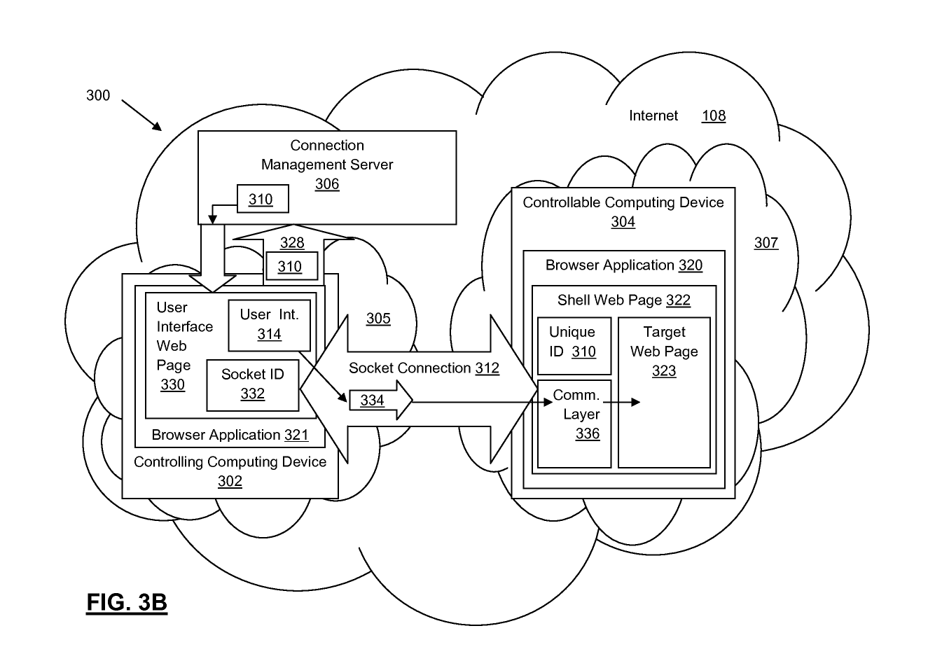

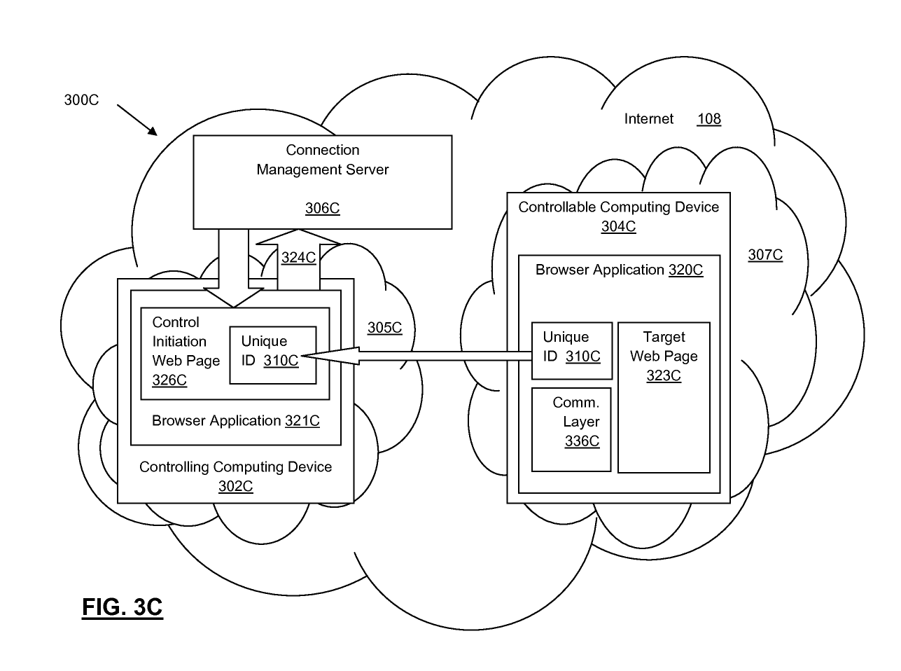

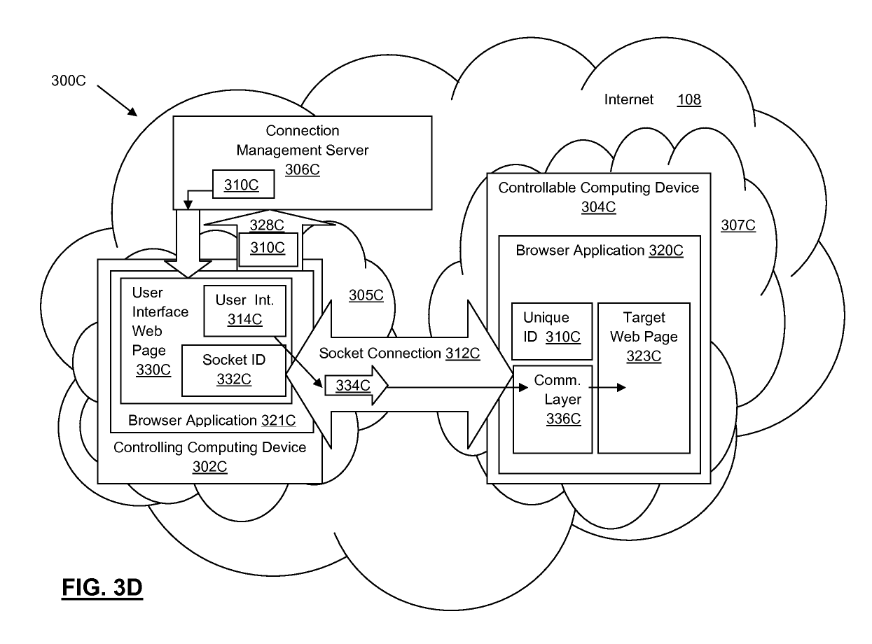

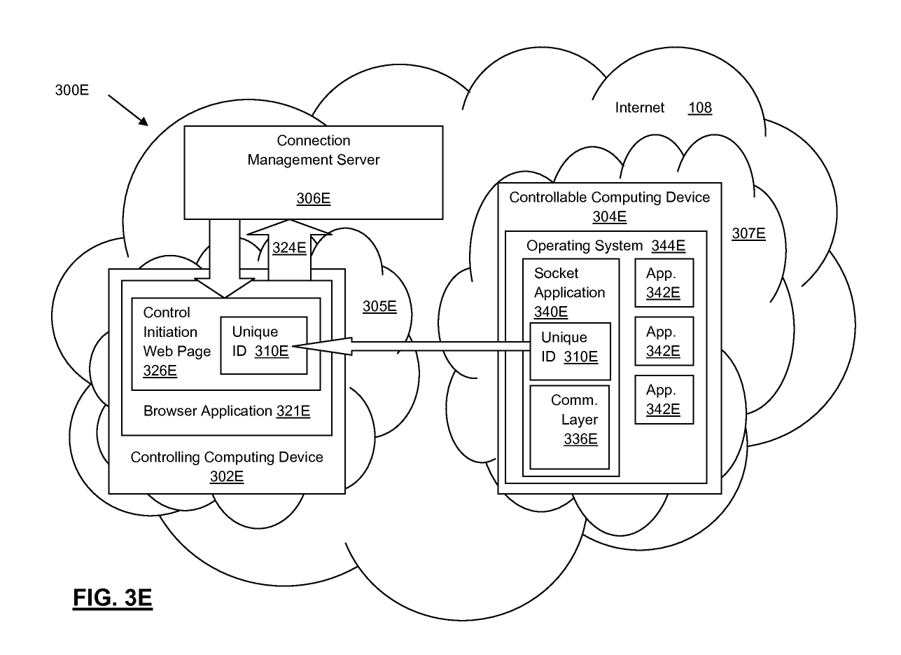

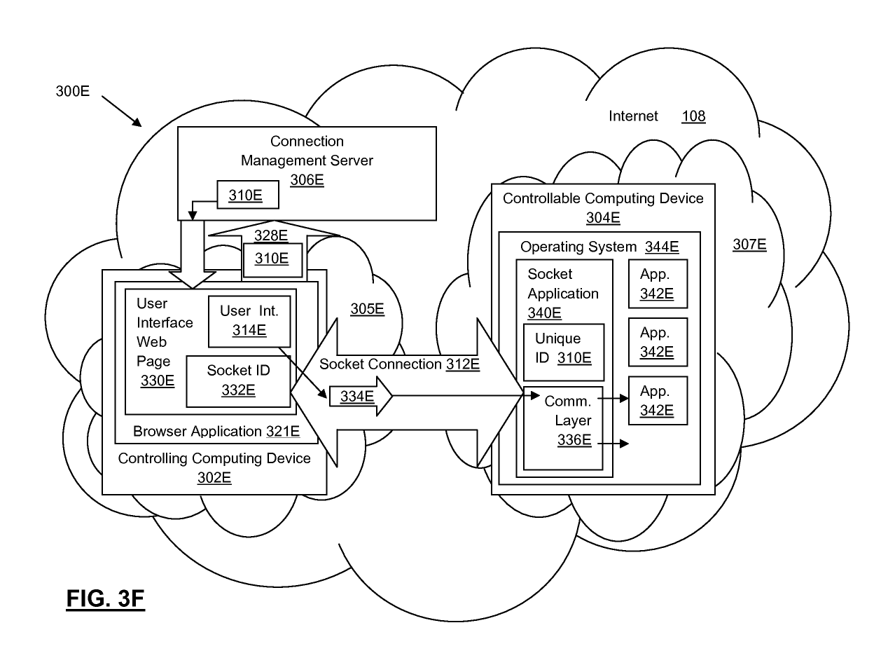

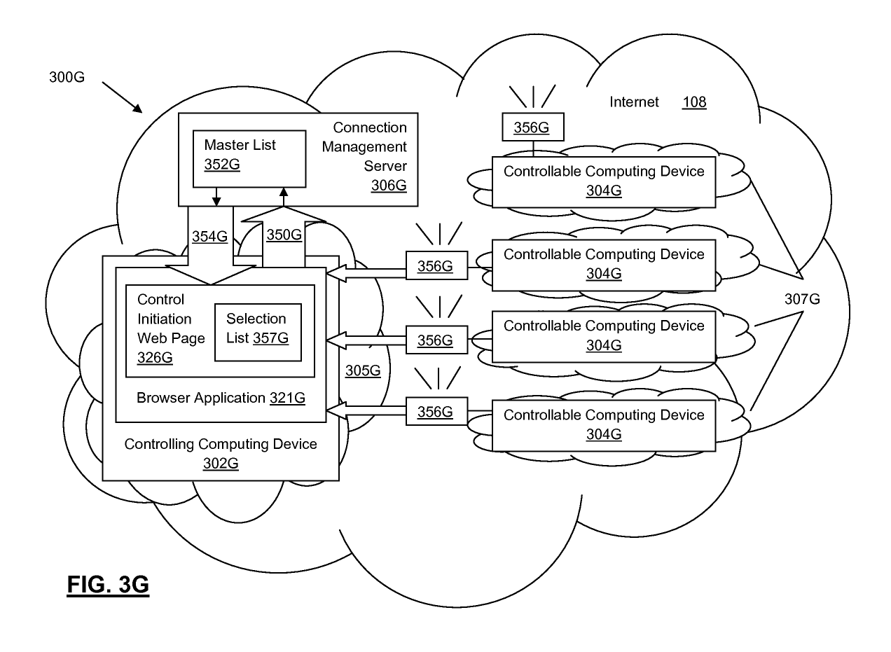

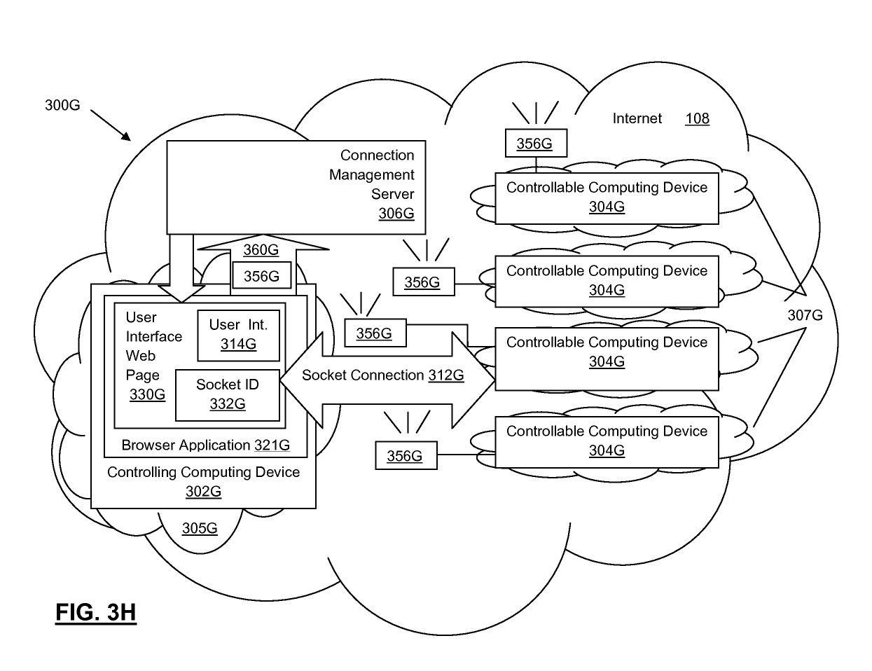

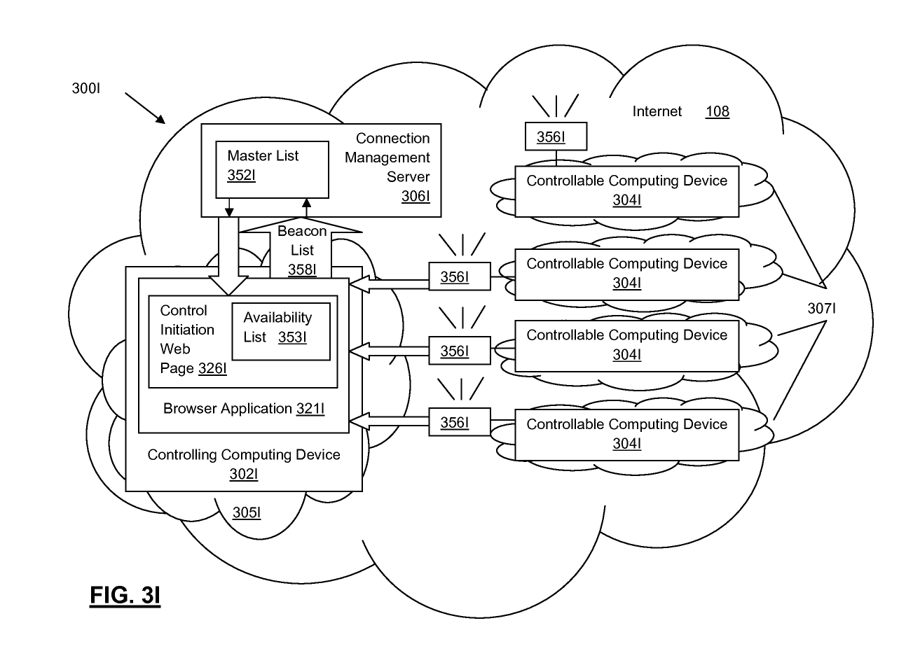

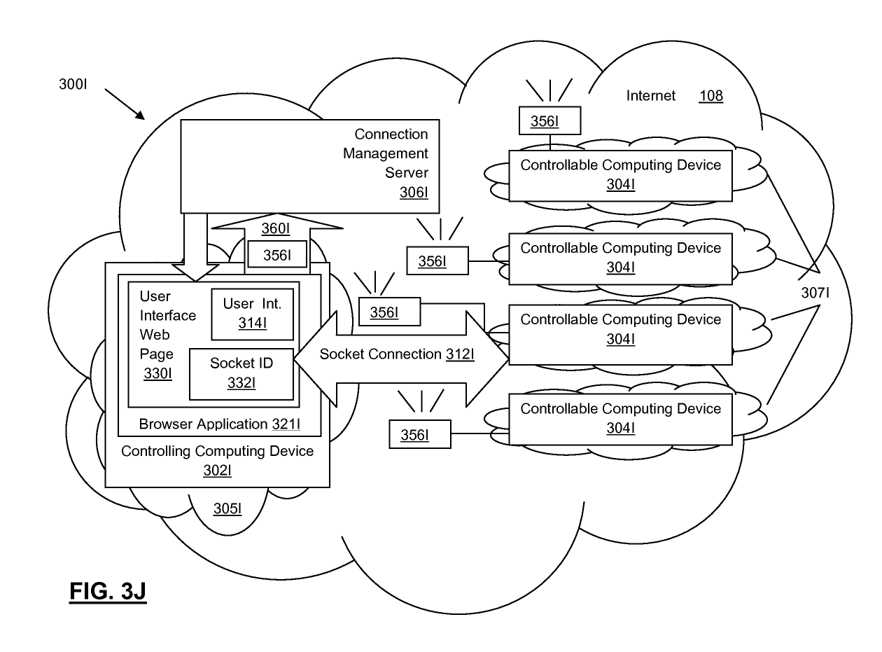

Reference is now made to FIGS. 3A and 3B, which illustrate in more detail a particular exemplary implementation of the system shown generally in FIG. 1, and corresponding reference numerals are used to refer to corresponding features in FIG. 3, except with the prefix “3” instead of “1”. The Internet continues to be denoted by reference numeral 108.

In the exemplary implementation shown in FIGS. 3A and 3B, a controllable computing device browser application 320 is running on the controllable computing device 304, and a controlling computing device browser application 321, which supports web sockets, is running on the controlling computing device 302.

The controllable computing device browser application 320 is specialized, and is configured, for example by the operator of the controllable computing device 304, to display a shell web page 322. The shell web page 322 acts as a frame that displays a target web page 323, which typically includes desired content, and the shell web page 322 also displays the unique identifier 310 associated with the controllable computing device 304. The unique identifier 310 will typically be obtained from the connection management server 306. The unique identifier 310 is aligned to the controllable computing device 304, and does not change when the target web page 323 changes. Optionally, the connection management server 306 may be sensitive to the target web page 323, and may select the user interface 314 to send to the controlling computing device 302 from a plurality of user interfaces 314 based on the then-current target web page 323.

As shown in FIG. 3A, to initiate the procedure for the controlling computing device 302 to obtain control over the specified functionality on the controllable computing device 304, a user of the controlling computing device 302 will cause the controlling computing device browser application 321 to send a request 324 to the connection management server 306. For example, the user may manually enter a URL pointing to the connection management server 306, scan a QR code or execute a link. The connection management server 306 will return a control initiation web page 326 to the controlling computing device browser application 321. The control initiation web page 326 receives the unique identifier 310. For example, the user may manually enter the unique identifier 310 into a form field on the control initiation web page 326, or the controlling computing device browser application 321 may support automatic filling of the form field from a scanned barcode, QR code, or other scanned unique identifier 310.

Referring now to FIG. 3B, after the unique identifier 310 has been provided to the control initiation web page 326, the user would then cause the controlling computing device browser application 321 to send a further request 328 to the connection management server 306, which further request 328 contains the unique identifier 310 or information derived therefrom. In response to the further request 328, the connection management server 306 uses the unique identifier 310, either directly or by using information derived from the unique identifier 310, to identify the appropriate user interface web page 330 for the controllable computing device 304 corresponding to that unique identifier 310. The connection management server 306 then returns the identified user interface web page 330 to the controlling computing device 302. The user interface web page 330 contains the user interface 314, which in this embodiment is an HTML page encoded for receiving touch-screen input. Optionally, the connection management server 306 may detect whether the controlling computing device 302 is a touch-screen device, for example by way of the screen resolution, and the user interface 314 may comprise an overlay of touch-actuable coordinates on the HTML page. Since the user interface 314 is predefined, the user interface 314 may be limited to a predefined set of commands associated with specified functionality on the controllable computing device 302. The specified functionality may be limited, for example, to a specific application, part of a specific application, or to a particular file or type of file. The user interface web page 330 also contains a socket identifier 332, which in this embodiment is HTML code for creating a web socket connection 312 with the controllable computing device 304.

In an alternative embodiment, the user may send a single request to the connection management server 306, which single request contains the unique identifier 310 or information derived therefrom, and the connection management server 306 may immediately return the user interface web page 330, without any need to use the control initiation web page 326. For example, a QR code may provide a URL that points directly to the user interface web page 330.

Continuing to refer to FIG. 3B, the controllable computing device browser application 320 is configured to allow a socket connection to be received by the shell web page 322, and therefore loading the user interface web page 330 into the controlling computing device browser application 321 effects the socket connection 312 to the shell web page 322 by execution of the browser-executable code comprising the socket identifier 332. Thus, the connection management server 306 uses the unique identifier 310 to facilitate a connection between the controllable computing device 304 and the controlling computing device 302 by providing the user interface web page 330 containing the socket identifier 332 to the controlling computing device browser application 321.

With the socket connection 312 established, by touching elements of the user interface 314 defined in the user interface web page 330 displayed within the controlling computing device browser application 321, the user can send control signals 334 from the controlling computing device 302 through the socket connection 312 to the controllable computing device 304. In the embodiment illustrated in FIG. 3, the controllable computing device browser application 320 is configured to allow the control signals 334 to pass through to the shell web page 322, which includes a communication layer 336, in the form of HTML code, which receives the control signals 334 from the controlling computing device 302, interprets them, and passes the commands indicated by the control signals 334 to the target web page 323.

FIGS. 3C and 3D show an alternative embodiment 300C of the system shown in FIGS. 3A and 3B, in which like elements are denoted by like reference numerals except with the suffix “C”. The alternative embodiment 300C shown in FIGS. 3C and 3D is similar to the embodiment 300 shown in FIGS. 3A and 3B, except that controllable computing device browser application 320C is modified to enable the shell web page 322 (FIGS. 3A and 3B) to be eliminated, and the target web page 323C is displayed in the main frame of the controllable computing device browser application 320C. In such an embodiment, the controllable computing device browser application 320C is modified to display the unique identifier 310C, to directly receive the socket connection 312C from the controlling computing device 302C and to include the communication layer 336C that receives and interprets the control signals 334C and passes the corresponding commands to the target web page 323C.

FIGS. 3E and 3F show a further alternative embodiment of the system shown in FIGS. 3A and 3B, in which like elements are denoted by like reference numerals except with the suffix “E”. In the alternative embodiment 300E shown in FIGS. 3E and 3F, rather than providing a shell web page 322 (FIGS. 3A and 3B) or configuring the controllable computing device browser application 320 (FIGS. 3A and 3B) to receive the socket connection 312 (FIGS. 3C and 3D), the controllable computing device 304E is provided with a separate socket application 340E for receiving the socket connection 312E from the controlling computing device 302E. The separate socket application 340E may display the unique identifier 310E, and includes an appropriate communication layer 336E that receives and interprets the control signals 334E and passes the corresponding commands. As best seen in FIG. 3F, the socket application 340E may be given permission to pass commands to certain other applications 342E or parts thereof, thereby enabling the controlling computing device 302E to have limited control over the controllable computing device 304E, or may be given permission to pass commands to any application 342E, as well as to the operating system 344E, so that the controlling computing device 302E will have virtually complete control over the controllable computing device 304E. In such an embodiment, the socket application 340E may be sensitive to the particular application 342E that is active, and the user interface 314E sent to the controlling computing device 302E may depend on the active application 342E, and a new user interface 314E may be automatically sent to the controlling computing device 302E when the active application 342E changes.

Although the operating system 344E is shown only in FIGS. 3E and 3F, it will be appreciated in the embodiments shown in FIGS. 3A to 3D as well, and is omitted from those figures only for ease of illustration.

As noted above, in particular embodiments a WiFi beacon may be used as a unique identifier. Two exemplary such embodiments will now be described.

A first exemplary embodiment 300G of a system in which a WiFi beacon is used as a unique identifier is shown in FIGS. 3G and 3H, in which elements corresponding to those in FIGS. 3A to 3F are denoted by corresponding reference numerals, except with the suffix “G”. Referring first to FIG. 3G, the controlling computing device browser application 321G is configured to provide location information 350G, such as from a GPS system or triangulation, to the connection management server 306G. The connection management server 306G checks the location information 350G against a master list 352G of controllable computing devices 304G to determine which controllable computing devices 304G are within a predetermined proximity to the controlling computing device 302G, based on the location information 350G. The connection management server 306G then returns a proximity list 354G to the controlling computing device browser application 321G, as well as a control initiation web page 326G. The proximity list 354G identifies the controllable computing devices 304G are within a predetermined proximity to the controlling computing device 302G, and also provides information about the WiFi networks associated with those controllable computing devices 304G. The information included in the proximity list 354G may include information enabling hidden WiFi networks corresponding to the controllable computing devices 304G on the proximity list 354G to be detected. The controlling computing device browser application 321G then listens for the WiFi beacons 356G corresponding to the controllable computing devices 304G on the proximity list 354G, and presents the user with a selection list 357G of those controllable computing devices 304G on the proximity list 354G whose corresponding WiFi beacons were detected.

Referring now to FIG. 3H, the user can then select one of the controllable computing devices 304G on the selection list 357G, and the controlling computing device browser application 321G will send the selection 360G to the connection management server 306G, which uses the WiFi beacon 356G indicated by the selection 360C as the unique identifier to determine and then return to the controlling computing device browser application 321G the user interface web page 330G to establish the socket connection 312G to the controllable computing device 304G corresponding to the WiFi beacon 356G indicated by the selection 360G. By restricting the proximity list 354G to controllable computing devices 304G that are within a predetermined proximity to the controlling computing device 302G, location-based limitations or “geo-gating” may be applied where desirable.

FIGS. 3I and 3J show a second exemplary embodiment 300I of a system in which a WiFi beacon is used as a unique identifier. In FIGS. 3I and 3J, elements corresponding to those in FIGS. 3A to 3H are denoted by corresponding reference numerals, except with the suffix “I”.

Referring first to FIG. 3I, the controlling computing device browser application 321I listens for WiFi beacons 356I, and then transmits a beacon list 358I of detected WiFi beacons 356I to the connection management server 306I. The connection management server 306I checks the beacon list 358I against a master list 352I of controllable computing devices 304I to determine which of the detected WiFi beacons 356I correspond to controllable computing devices 304I available for control by the controlling computing device 302I. The connection management server 306I then returns a control initiation web page 326I to the controlling computing device browser application 321I. The control initiation web page 326I includes an availability list 353I, which identifies the controllable computing devices 304I whose WiFi beacons 356I were detected by the controlling computing device browser application 321I and were identified from the master list 352I as being available for control by the controlling computing device 302I, and the availability list 353I is presented to the user. As shown in FIG. 3J, the user can select one of the controllable computing devices 304I on the availability list 353I, and the controlling computing device browser application 321I will send the selection 360I, which identifies the corresponding WiFi beacon 356I serving as the unique identifier, to the connection management server 306I. The connection management server 306I then returns the user interface web page 330I to the controlling computing device browser application 321I to establish the socket connection 312I.

The proximity list 354G (FIG. 3G) and the availability list 353I (FIG. 3I) each preferably include confirmation codes, such as alphanumeric codes, which confirmation codes are also displayed on the controllable computing devices 304G, 304I, to enable the user to verify that the user is obtaining control over the desired controllable computing device 304G, 304I prior to sending the selection 360G, 360I to the connection management server 306G, 306I.

It should be noted here that in the exemplary embodiments 300G, 300I described above, the controlling computing device 302G, 302I does not actually connect to the wireless network of the relevant controllable computing device 304G, 304I, and as such these wireless networks may remain secured. The connection between the controlling computing device 302G, 302I and the relevant controllable computing device 304G, 304I is a socket connection via the Internet 108. It will also be noted that the controlling computing device browser application 321G, 321I may of course cooperate with the operating system or other applications on the controlling computing device 302I, 302G to obtain location information 350G and to detect the WiFi beacons 356G, 356I.

Additionally, it should be noted that the controlling computing device 302, 302C, 302E, 302G, 302I may have a dedicated application for connecting to the respective controllable computing device 304, 304C, 304E, 304G, 304I, rather than a browser application 321, 321C, 321E, 321G, 321I. In such cases a socket utilizing the Internet would be provided, but need not necessarily comprise a complete web page.

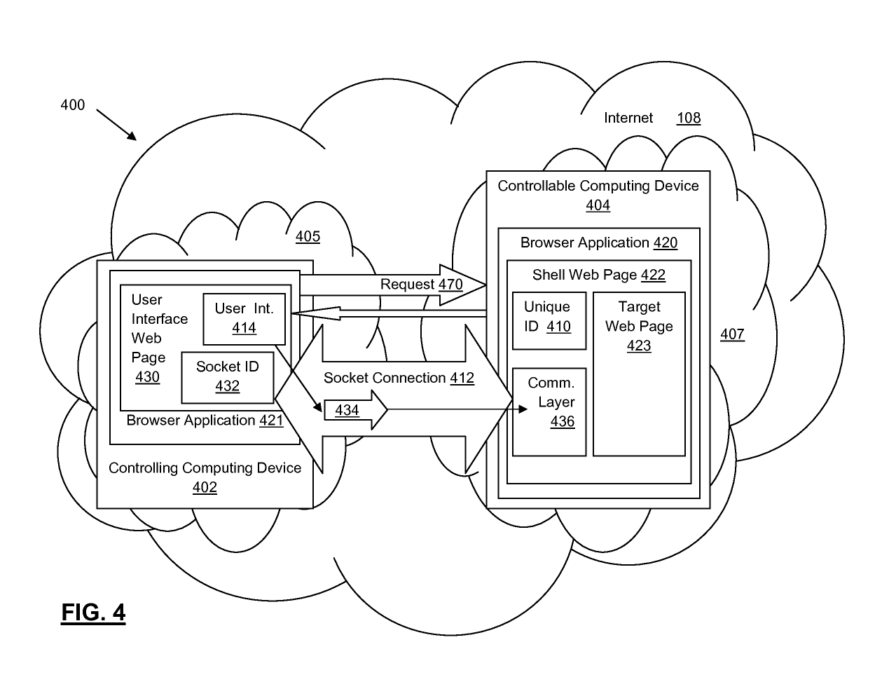

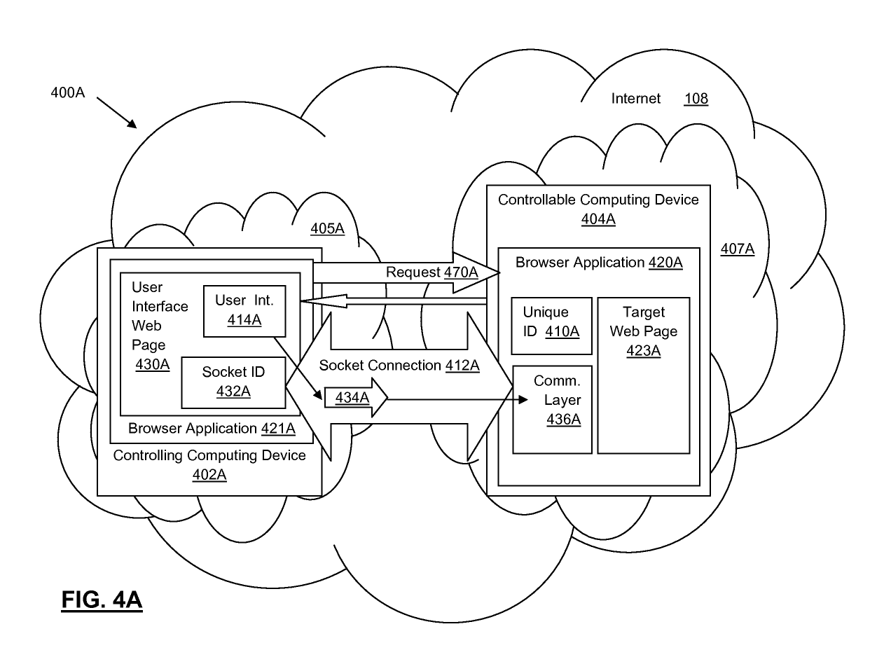

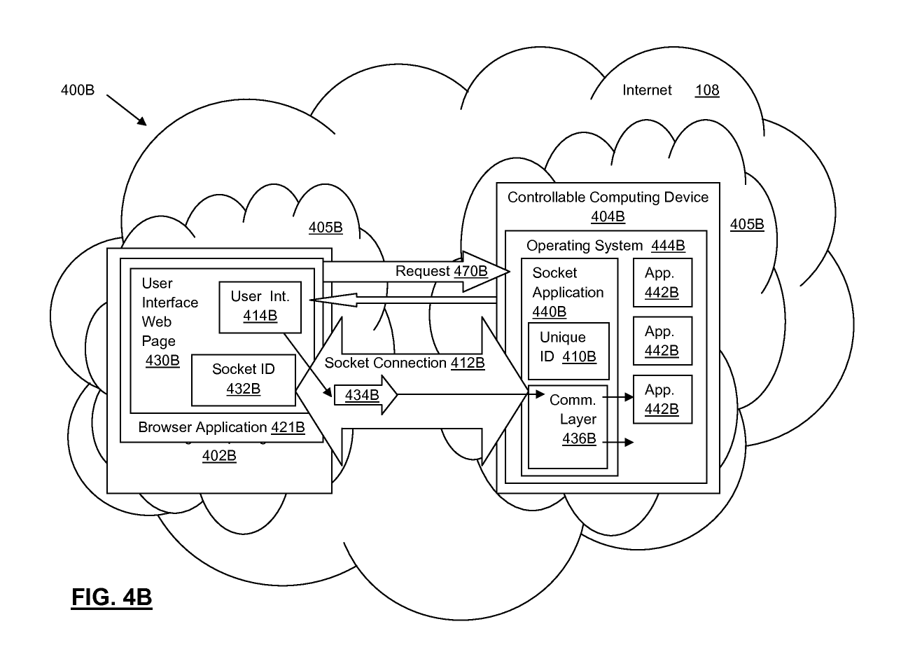

Referring now to FIG. 4, an alternative configuration of a system for enabling a controlling computing device connected to an interconnecting network to control specified functionality of a controllable computing device connected to the interconnecting network is shown generally at 400. The alternatively configured system 400 is similar to the system 300 shown in FIG. 3, except that the alternatively configured system 400 does not include a connection management server, with the controllable computing device 404 being configured to act as a server to provide a user interface web page 430 to the controlling computing device 402. Corresponding reference numerals are used to refer to features in the alternatively configured system 400 that correspond to features in the system 300 shown in FIG. 3, except with the prefix “4” instead of “3”.

At least one unique identifier 410 is presented at the controllable computing device 404, independently of any user interaction with the controllable computing device 404. In the exemplary system 400 shown in FIG. 4, the at least one unique identifier 410 contains sufficient information to enable the controlling computing device 402 to generate a request 470 to the controllable computing device 404, acting as a server, for the user interface web page 430 corresponding to the controllable computing device 404. The unique identifier 410 may be, for example, a URL, an alphanumeric code, a WiFi beacon, a QR code, a bar code or an e-mail address. Typically, the unique identifier 410 will be a URL from a web connection to the socket connection 412, via the Internet. Where the unique identifier is a WiFi beacon, the network name may be set to the relevant URL so that the URL can be captured by the controllable computing device browser application 422.

The user interface web page 430 contains a user interface 414, for example an HTML page encoded for receiving touch-screen input, and also contains a socket identifier 432, for example HTML code for creating a web socket connection with the controllable computing device 404. The controllable computing device browser application 420 is configured to allow a socket connection to be received by the shell web page 422. Thus, loading the user interface web page 430 into the controlling computing device browser application 421 effects the socket connection 412 to the shell web page 422 by execution of the HTML code comprising the socket identifier 432.

FIGS. 4A and 4B show, respectively, alternative embodiments 400A and 400B of the alternatively configured system 400 which, aside from omission of the connection management server and the controlling computing device acting as a server, are similar to the alternative embodiments 300C and 300E shown in FIGS. 3C and 3D and 3E and 3F, respectively, and hence corresponding reference numerals are used to refer to corresponding features, only with the prefix “4” rather than “3” and the suffix “A” and “B” rather than “C” and “E”, respectively.

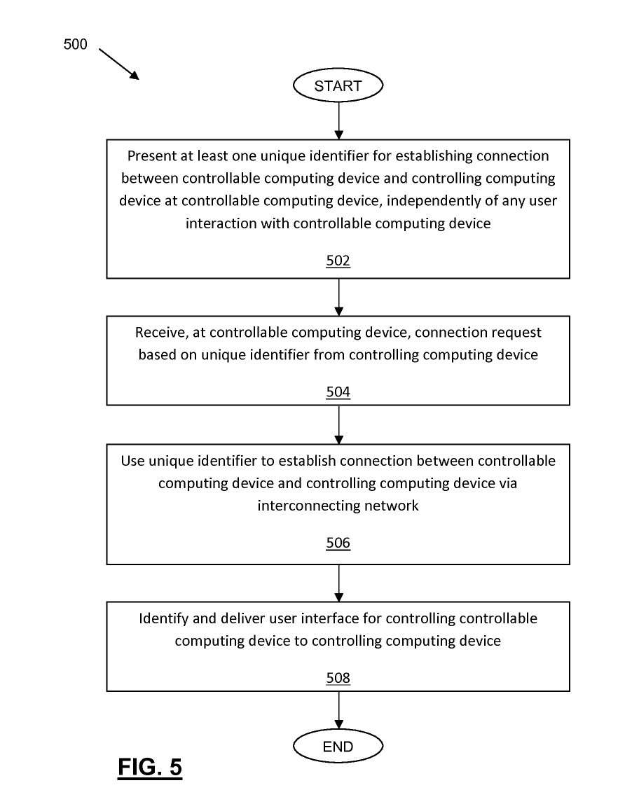

FIG. 5 is a flow chart showing an exemplary method 500 for enabling a controlling computing device (such as controlling computing device 402, 402A, 402B) connected to an interconnecting network such as the Internet to control specified functionality of a controllable computing device (such as controllable computing device 404, 404A, 404B) connected to the interconnecting network. At step 502, at least one unique identifier for establishing a connection between the controllable computing device and the controlling computing device is presented at the controllable computing device, independently of any user interaction with the controllable computing device. At step 504, the controllable computing device receives a connection request from the controlling computing device based on the unique identifier. At step 506, in response to the connection request, the unique identifier is used to establish a connection between the controllable computing device and the controlling computing device via the interconnecting network, and at step 506, the controllable computing device identifies and delivers a user interface to the controlling computing device for controlling the controllable computing device.

Systems according to aspects of the present invention for enabling a controlling computing device connected to an interconnecting network to control a controllable computing device connected to the network facilitate a wide variety of practical applications. The control and interactivity provided by the user interface may be layered over existing content.

In one embodiment, the controllable computing device may be a user's personal computer, and the controlling computing device may be that same user's mobile computing device, such as a tablet computer or smartphone. By obtaining a user interface in accordance with aspects of the present invention, the user's mobile device can become a specialized control peripheral, in addition to the keyboard and mouse, for controlling applications on the user's personal computer. The user interface may, as described above, be specialized for the particular application being controlled.

In another embodiment, a restaurant or a store may place a monitor inside their retail location, or in a window. The monitor may be coupled to a computer connected to an interconnecting network, such as the Internet, and appropriately configured as described above so that the computer can be a controllable computing device as described above. For example, the computer may cause the connected monitor to display a web browser displaying a shell web page that shows the unique identifier and frames, as the target web page, a web page for the store or restaurant. A customer or potential customer could then use an Internet-connected mobile device, such as a smartphone, to log onto the connection management server, enter the unique identifier, and then receive a user interface enabling the user to interact with the target web page displayed on the monitor. For example, in the case of a restaurant the user could interact with the target web page to obtain nutritional information about food sold by the restaurant, and in the case of a store the user could interact with the target web page to make inquiries into the store catalogue. In each case, the results would be displayed on the monitor, although additional results may be shown on the mobile device, along with the user interface. Similarly, a mall display may take the form of a large monitor coupled to an Internet-connected computer configured to be a controllable computing device, enabling a user to use an Internet-connected smartphone to obtain an interface for interacting with the mall display to obtain detailed directions, including GPS-based or WiFi triangulation based directions, and to call up web sites for a specific store in the mall. Again, the results of the interaction would be displayed on the large monitor in the mall display, although additional results may be shown on the mobile device display. In certain embodiments, coupons or other promotional material can be delivered to the user's mobile device. Thus, a wide variety of advertising options are enabled by aspects of the present invention.

In addition, in certain embodiments the user interface on the controlling computing device can enable the user to provide content to the controllable computing device. For example, an Internet-connected computer whose monitor is displaying a poster for a movie, when configured as a controllable computing device according to an aspect of the present invention, may enable a user to take a photograph of him or herself, such as with a built-in camera on his or her smartphone, and insert the photograph into a predetermined location in the poster. A similar arrangement can be used in social venues such as nightclubs to enable a user to announce his or her arrival by displaying a photo of him or herself on a large screen above the dance floor or other mixing area.

Systems according to aspects of the present invention may be adapted to support control of specified functionality on the controllable computing device by more than one controlling computing device. Such adaptation is within the capability of one skilled in the art, now informed by the herein disclosure. For example, the communications from each controlling computing device may carry a controlling computing device identifier for uniquely identifying that controlling computing device.

In one exemplary implementation, the controllable computing device is running a video game, such as poker, and is coupled to a monitor which provides a main display of the game. Users can use their Internet-connected smartphones as controlling computing devices to play the game, and the users can view their cards on the local screen of their respective smartphones without the cards being visible on the monitor. Similarly, aspects of the present invention may be used to enable multi-player video gaming in a venue such as a movie theatre, with users' smartphones serving as game controllers. In such embodiments, use of the systems illustrated in FIGS. 4, 4A and 4B, in which the connection management server is omitted, may be more efficient than having each user's mobile device separately communicate with a connection management server.

In some embodiments, the controllable computing device may be an Internet-connected video game console, such as a Sony PlayStation 3, Nintendo Wii, Microsoft Xbox 360, or the like, or a conventional computer running a video game. In such embodiments, the required functionality may be provided by the console hardware or firmware, or by the software of a particular game, or may be specialized software. The controlling computing device may be, for example, a touch-screen device such as an Internet-connected tablet computer or smartphone, which may be used to replace an existing game controller, or as a supplement to an existing game controller, for example by physically attaching the tablet computer or smartphone to the controller using a specialized clip. The user interface on the controlling computing device may include an additional game display, and may provide for a single action on the user interface to send input to the controllable computing device that is equivalent to a complex series of inputs on the original game controller. Depending on the control options set for the user interface on the controlling computing device, specialized in-game features, such as special in-game equipment, may be provided via the user interface on the controlling computing device.

Aspects of the present invention may also support interactive polling, for example in movie theatres, or in a classroom setting to facilitate examinations. Feedback, for example rewards such as electronic coupons in the case of commercial polling, may be pushed to the controlling computing device.

Aspects of the present invention are also directed to enabling users to create, modify and socialize user interfaces for various applications.

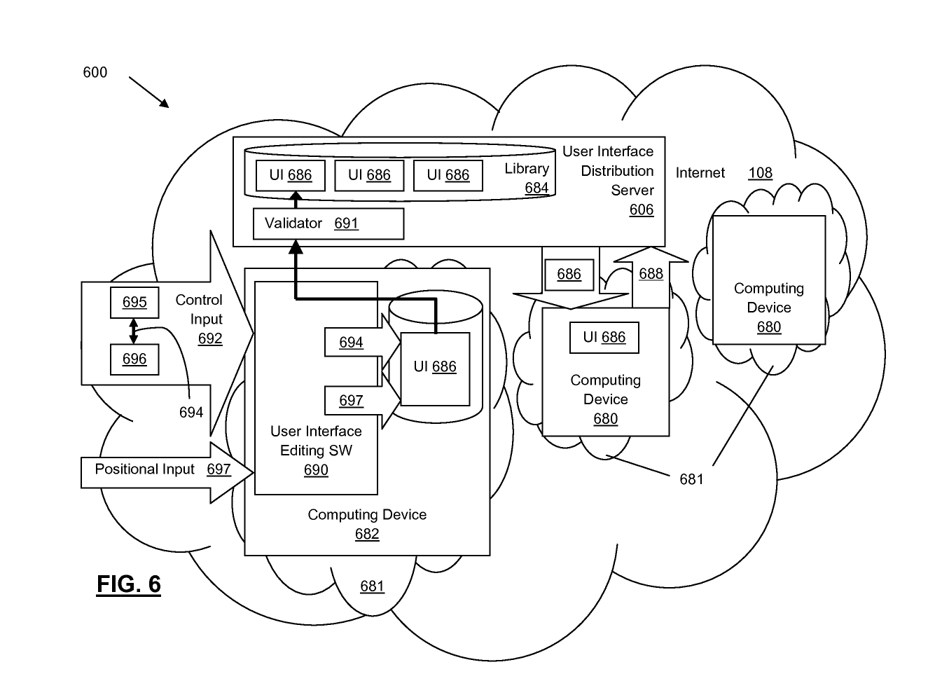

Referring now to FIG. 6, an exemplary system for creation, modification and distribution of user interfaces is shown generally at 600. The system 600 comprises a user interface distribution server 606 connected to an interconnecting network, in this case the Internet 108, and a plurality of computing devices 680, 682 also connected to the Internet 108. The computing devices 680, 682 may be connected to the Internet 108 via respective local networks 681.

The user interface distribution server 606 stores a library 684 of predefined user interfaces 686. The user interfaces 686 in the library 684 may be associated with various different software applications, and may include a subset of different user interfaces 686 associated with a single software application; that is, for a given software application such as photo editing software, spreadsheet software or video game software, the library 684 may include a plurality of different user interfaces 686 each associated with that particular software application.

The user interface distribution server 606 is accessible via the Internet 108 by the computing devices 680, 682 and hence accessible to a plurality of parties, and the user interfaces 686 may be made available for download to at least some of those computing devices 680, 682 and hence made available to at least some of those parties. In response to a request 688 from an authorized one of the computing devices 680 for a particular one of the user interfaces 686, the user interface distribution server 606 transmits that particular user interface 686 to the requesting computing device 680. The system 600 for creation, modification and distribution of user interfaces may be integrated with the above-described systems for enabling a controlling computing device to control a controllable computing device, and the interface distribution server 606 may also be a connection management server as described above. Thus, the user interfaces 686 in the library 684 may enable control, from a controlling computing device connected to the Internet 108, of specified functionality of a controllable computing device also connected to the Internet 108. Accordingly, the request 688 may be one of the requests 328, 328C, 328E or the selections 360G, 360I described above in the context of the systems 300, 300C, 300E, 300G, 300I, and the user interface 686 transmitted to the controlling computing device 300, 300C, 300E, 300G, 300I may be the user interface 314, 314C, 314E, 314G, 314I contained within a user interface web page 330, 330C, 330E, 330G, 330I transmitted to the controlling computing device 302, 302C, 302E, 302G, 302I to enable the controlling computing device 302, 302C, 302E, 302G, 302I to control the controllable computing device 304, 304C, 304E, 304G, 304I.

Various applications, such as commercial software applications like word processors, photo editors, spreadsheets and video games, and various files, such as a particular company's web site, may have default user interfaces associated therewith, typically created by the provider of the application or file or by an associated party. Users may be permitted to modify these default user interfaces, or create their own user interfaces based on their personal preferences. Typically, even where users are permitted to create or modify user interfaces where a default user interface exists, the default user interface would retain the primary association with the relevant application or file.

In the exemplary system 600 shown in FIG. 6, at least one of the computing devices 682 has user interface editing software 690 installed thereon. The user interface editing software 690 enables a user of the computing device 682 to create a new user interface or to modify an existing user interface. The user interface editing software 690 can receive one of the user interfaces 686 from the user interface distribution server 606, and can transmit a newly created or modified user interface 686 to the user interface distribution server 606 for storage in the library 684. Thus, the user interface distribution server 606 can receive additional user interfaces 686 from third parties, which may be new user interfaces 686 or modified user interfaces 686, and add those additional user interfaces 686 to the library 684. Preferably, the user interface distribution server 606 includes a validator 691, such as a javascript program, which, before adding an additional user interface 686 to the library 684, validates the additional user interface 686, and only adds the additional user interface 686 to the library 684 in response to successful validation of the additional user interface 686. The validator 691 may check for errors in the user interface 686 that would interfere with its effective functionality, or may check to see whether the author or submitter of the user interface 686 is authorized to create or modify user interfaces for the application or content with which that user interface 686 is associated. For example, a company may have created a specific user interface 686 for use with that company's web site so as to provide a customized, branded browsing experience, and therefore may wish to prevent third parties from placing new or modified user interfaces for that web site on the user interface distribution server 606. In such a case, where the validator 691 detects that a user interface 686 submitted for that company's web site was not submitted by a party authorized by that company, the validator 691 would prevent that user interface 686 from being stored on the user interface distribution server 606 and return a suitable message to the submitter. Alternatively, the validator 691 could allow that user interface 686 to be stored as a non-default user interface. In other embodiments, all user interfaces 686 may be accepted into the library 684, but only those user interfaces 686 that were successfully validated would be made available to parties other than the submitter.

As noted above, in one embodiment the user interfaces 686 in the library 684 may enable control, from a controlling computing device connected to an interconnecting network such as the Internet 108, of specified functionality of a controllable computing device also connected to the interconnecting network. Accordingly, the user interface editing software 690 enables a user thereof to define such a user interface 686. The user interface editing software 690 receives control input 692 comprising associations 694 between actions 695 on the controlling computing device and commands 696 for controlling the specified functionality of the controllable computing device, and then stores the associations 694, typically along with the actions 695 and commands 696, as part of a user interface 686. The user interfaces 686 may be stored using a suitable markup language such as XML, and may be stored locally by the computing device 682 and then transmitted to the user interface distribution server 606, or may only be retained in non-persistent memory on the computing device 682, with the persistent storage of the user interface 186 being on the user interface distribution server 606.

The commands 696 with which the actions 695 on the controlling computing device are associated may comprise individual inputs such as keystrokes, button presses, joystick movements or mouse clicks, or combinations of such individual inputs. For example, in a user interface 686 for a video game, a single action 695 on the controlling computing device may be mapped to an ordered sequence of button presses on a game controller, enabling a single command on the controlling computing device to execute a complicated technique on the controllable computing device executing the video game software. In one embodiment, where a “special move” in a video game requires a precise series of several inputs on the game controller, a user may build a user interface 686 for that video game in which a single action 695, such as touching a single touch-actuable widget, maps to commands 696 corresponding to that precise series of inputs on the game controller. As a result, a single action on the controlling computing device can execute the “special move” in the video game. Similar techniques can be used to allow a single action on the controlling computing device to execute more complicated, multi-command processes in other types of software, such as word processing software, spreadsheet software, photo editing software, and so on. The commands 696 with which the actions 695 on the controlling computing device are associated may also comprise individual functions of an application on the controllable computing device, such as “cut”, “paste” or “increase font”, or may comprise ordered combinations of individual functions. Where a user interface 686 is to be used with an application that runs on an Apple Macintosh computer, the commands 696 with which the actions 695 on the controlling computing device are associated may include AppleScripts.

The actions 695 on the controlling computing device may comprise button presses or combinations of button presses on the hardware of the controlling computing device, and where the controlling computing device includes an in-built accelerometer, the actions 695 can also include the signals from the accelerometer. In a preferred embodiment, the user interfaces 686 are adapted for use with controlling computing devices that are touch-screen devices. In such an embodiment, the actions 695 on the controlling computing device that are associated with the commands 696 on the controllable computing device will comprise actuation of touch-actuable widgets, and the user interface editing software 690 also receives positional input 697 establishing a positional layout of the touch-actuable widgets on a screen of the touch-screen device and stores the positional layout as part of the user interface 686. The touch-actuable widgets are individual touch controllers, such as buttons, sliders, rotators and virtual joysticks, and can be assigned various desired shapes, icons, colors, sizes, and so on. Individual touch-actuable widgets may be assembled into groups having a defined layout based on a common purpose or related functions, and the groups can be assembled (with or without additional individual touch-actuable widgets) according to a defined layout into “boards” occupying all or part of the screen on the touch-screen device. A user interface may consist of only a single board, or may comprise a plurality of boards, with the board displayed by the controlling computing device varying according to the context of the application or file being controlled. The positional layout of a given board may be mapped to the shape of a human hand, and may then be customized to a particular user's hand size and natural finger position. Thus, the look, feel and even the auditory feedback of a user interface 686 may be customized.

As noted above, various applications and files may have associated therewith default user interfaces 686 created by the provider of the application or file or by an associated party. These default user interfaces 686 may be distributed with the application or file, or may be distributed via the user interface distribution server 606. In some cases, the provider may wish to prevent any modification of that user interface 686, in which case that user interface 686 could be marked “no editing”, and the user interface editing software 690 could be configured to prevent editing of such default user interfaces 686. In other cases, the provider may wish to permit users to edit the default user interface 686 for their own use but prevent distribution of such edited user interfaces 686. In such instances, the validator 691 would prevent any edited version of that default user interface 686 from being stored on the user interface distribution server 606.

In still other cases, the provider of an application or file may have no objection to modification of the default user interface 686 or to distribution of such modified user interfaces 686 or to the creation and distribution of new user interfaces for the provider's application or files. Thus, users who are not affiliated with the provider of an application or file may create or modify user interfaces 686 and upload them to the user interface distribution server 606 to make the user interfaces 686 available to other users. In order to do so, a user may be required to register with the user interface distribution server 606, which may be configured to charge a fee for registration or for the download of certain user interfaces 686, and users may optionally also be required to register with the user interface distribution server 606 in order to download user interfaces 686. The user interface distribution server 606 may track the consanguinity of the various user interfaces 686, such as that a particular user interface 686 is user X's modification of user Y's modification of a default user interface 686. Users may facilitate distribution of user interfaces by sending tags, URLs or other links to particular user interfaces 686 on the user interface distribution server 606 via e-mail or social media. Additionally or alternatively, the user interface distribution server 606 may support browsing and searching of available user interfaces 686, which may be sorted by any suitable method, such as by associated application or file, alphabetically by name or creator, by user popularity or user ratings, or the like.

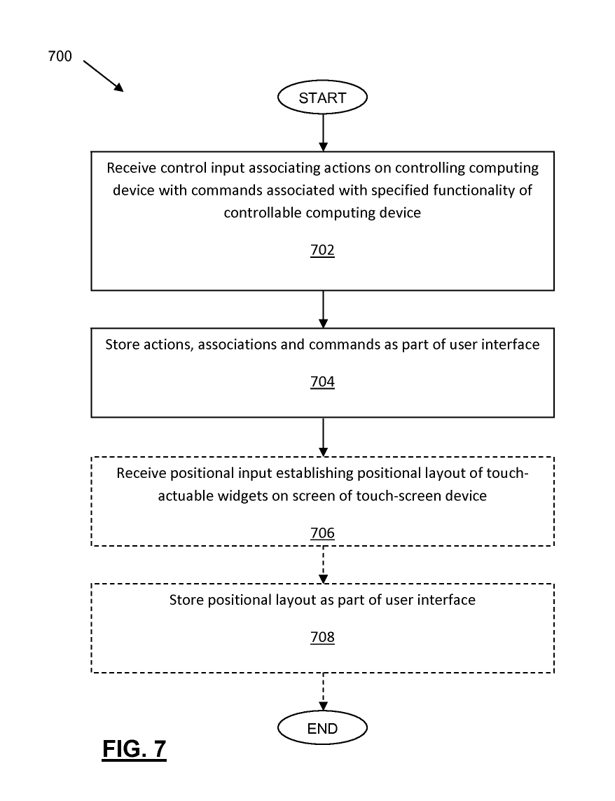

Reference is now made to FIG. 7, which is a flow chart showing an exemplary method 700 for defining a user interface for controlling, from a controlling computing device connected to an interconnecting network, specified functionality of a controllable computing device connected to the interconnecting network. The method 700 may be carried out by a computing device (such as computing device 682) running user interface editing software (such as user interface editing software 690), either alone or in combination with a user interface distribution server (such as user interface distribution server 606). The method 700 may be applied to create a new user interface or to modify an existing user interface. At step 702, the method 700 receives control input associating actions on the controlling computing device with commands associated with the specified functionality of the controllable computing device, and at step 704 the method 700 stores the actions, associations and commands as part of a user interface. At optional step 706, where the controlling computing device is a touch-screen device, the method 700 receives positional input establishing a positional layout of touch-actuable widgets on a screen of the touch-screen device and at optional step 708, the method 700 stores the positional layout as part of the user interface. The steps 702 to 708 may be performed in any suitable order, and may be performed repeatedly as a user interface is created or modified. The resulting user interface may be stored on a server accessible by a plurality of parties, with the user interface being made available to some or all of the parties.

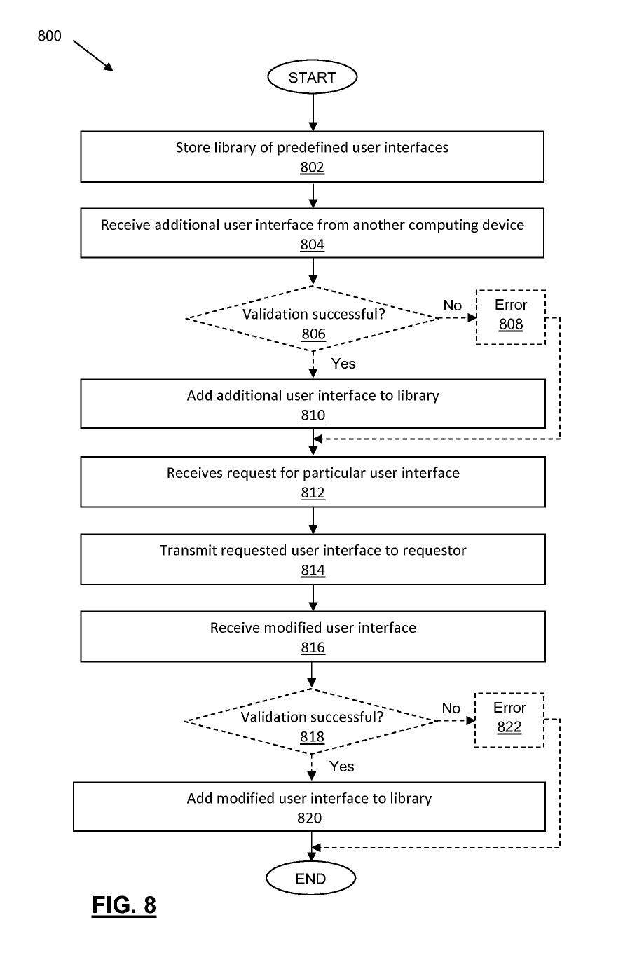

With reference now to FIG. 8, an exemplary method 800 for making user interfaces available is shown in flow chart form. The method 800 may be used, for example, to make available user interfaces that enable control, from a controlling computing device connected to an interconnecting network, of specified functionality of a controllable computing device connected to the interconnecting network. The method 800 may be carried out by a user interface distribution server, such as the user interface server 606 described above.

At step 802, the method 800 stores a library of predefined user interfaces. At step 804, the method 800 receives an additional user interface from another computing device, typically from a third party. At optional step 806, before adding the additional user interface to the library (step 810), the method 800 validates the additional user interface, for example by checking functionality or by checking authorship or modification permission as described above. If the validation is unsuccessful (“no” at step 806), the method 800 sends an error message 808 and proceeds to step 812, and if the validation is successful (“yes” at step 806), at step 810 the method 800 adds the additional user interface to the library and typically indexes it for searching. At step 812, the method 800 receives a request for a particular one of the user interfaces, for example from a controlling computing device as described above, and at step 814, in response to the request received at step 810, the method 800 transmits the requested user interface to the requestor, for example to a controlling computing device. At step 816, the method 800 receives a modified user interface, which is a modified version of the requested user interface transmitted at step 814, and at step 818, before adding the modified user interface to the library (step 820), the method 800 validates the modified user interface. If the validation is unsuccessful (“no” at step 818), the method 800 sends an error message 822 and then ends. In response to successful validation (“yes” at step 818), at step 820 the method 800 adds the additional user interface to the library and typically indexes it. The method 800 shown in FIG. 8 is merely an exemplary method for making user interfaces available, and other methods are also contemplated. For example, steps 804 to 810 may be omitted, and steps 816 to 820 may be omitted, or steps 804 to 810 may be carried out after step 814 and before step 816, or after step 820. Certain sets of steps may also be repeated.

One aspect of the present invention provides a management tool for sharing at least one user interface. The management tool monitors a computing device to determine an opened application and checks to see if the opened application has an associated user interface. If the management tool determines that the opened application has an associated user interface, the management tool then determines if the associated user interface is available locally. If the management tool determines that an associated user interface is not available locally, the management tool may prompt the user to allow download of an associated user interface from a proprietary third party content aggregator, for example by way of a user interface distribution server, or prompt the user to create a new user interface for the opened application.

Another aspect of the present invention provides a method for defining a touch-screen user interface for a touch-screen device. The method comprises associating the touch-screen user interface with at least one application and/or at least one document supported by the application, and then receiving user input establishing at least one positional layout of touch-actuable widgets, receiving user input establishing assignments of the touch-actuable widgets to respective application functions, operating system functions and/or device inputs such as keystrokes and mouse clicks, and bundling the widgets, the at least one positional layout, and the assignments as part of the touch-screen user interface. The touch-screen user interface may be published to a third party content aggregator server, such as a user interface distribution server, which may permit downloading of the touch-screen user interface. Upon uploading the touch-screen user interface to the third party content aggregator server, the third party content aggregator server may execute a validation routine on the uploaded touch-screen user interface, and only publish the touch-screen user interface in response to successful validation thereof.

A further aspect of the present invention provides a method of displaying a touch-screen user interface on a touch-screen device. The method detects the launch of an application or opening of a document or other content element on a computing device with which the touch-screen device can communicate, and checks whether either the computing device or the touch-screen device stores at least one touch-screen user interface that is associated with the application, document or other content element. If the method finds such a touch-screen user interface, the method automatically causes the stored touch-screen user interface to be launched on the touch-screen device. If the method does not find such a touch-screen user interface, the method checks to see if a remote publication server stores a touch-screen user interface that is associated with the application, document or other content element and, if one is found, facilitates downloading of that touch-screen user interface for loading onto the touch-screen device. The method may permit a user to select one of a plurality of touch-screen user interfaces associated with the application, document or other content element. The method may also permit the user to provide input modifying the downloaded touch-screen user interface and store the modified touch-screen user interface, and may further permit the user to publish the modified touch-screen user interface and its association with the application, document or other content element, for example by upload to a publication server, and permit download of the modified touch-screen user interface, either by the user or by third parties, or both. The method may automatically store a parent-child relationship between the originally downloaded touch-screen user interface and the modified touch-screen user interface.

Another aspect of the present invention provides a method for editorial control of a user interface. According to the method, a first party creates a user interface and provides it to a third party content aggregator, which may be a proprietary third party content aggregator. The third party content aggregator may allow a second party to download the user interface for editing, thereby creating a modified user interface. Depending on the authorizations of the second party, the second party may provide the modified user interface to the third party content aggregator.

Another aspect of the present invention provides a method for controlling a controlled device using a controlling device, such as a touch-screen device. The method monitors a user interface on the touch device, and notifies a controller in the event a touch is detected on the touch device. The touch is mapped to an event, such as an application function or series of functions, or a hardware input or series of inputs such as keystrokes or mouse clicks, and the method executes the event mapped to the touch on the controlled device.

A further aspect of the present invention is directed to a method comprising executing an application on a server computer, sending application data wirelessly to a client device, executing a corresponding touch-screen user interface associated with the application on the client device, with the touch-screen user interface providing at least one application function for controlling the application remotely.

An additional aspect of the present invention provides a method for controlling a client device configured to display a touch-screen user interface. The method comprises monitoring a server to determine an application being executed by the server, detecting an open file associated with the application, where the open file may have a touch-screen user interface associated therewith, and checking the client device to determine if the touch-screen user interface associated with the open file is being displayed on the client device. If the method determines that no touch-screen user interface associated with the open file is being displayed on the client device, the method opens the touch-screen user interface associated with the open file on the client device or prompts the user to create a new touch-screen user interface for the open file.

Another aspect of the present invention is directed to a method for communicating between a client and a server. The method comprises sending a server message from the server to the client, with the server message indicating a server protocol version, and sending a client message from the client to the server, with the client message indicating a client protocol version. The method compares the client protocol version to the server protocol version, and if the client protocol version is different from the server protocol version, the method updates the lower of the client and server protocol versions.

Aspects of the present invention may be implemented on any suitable computer or microprocessor-based system, and the controlling computing device is preferably a network-capable tablet computer or smartphone.

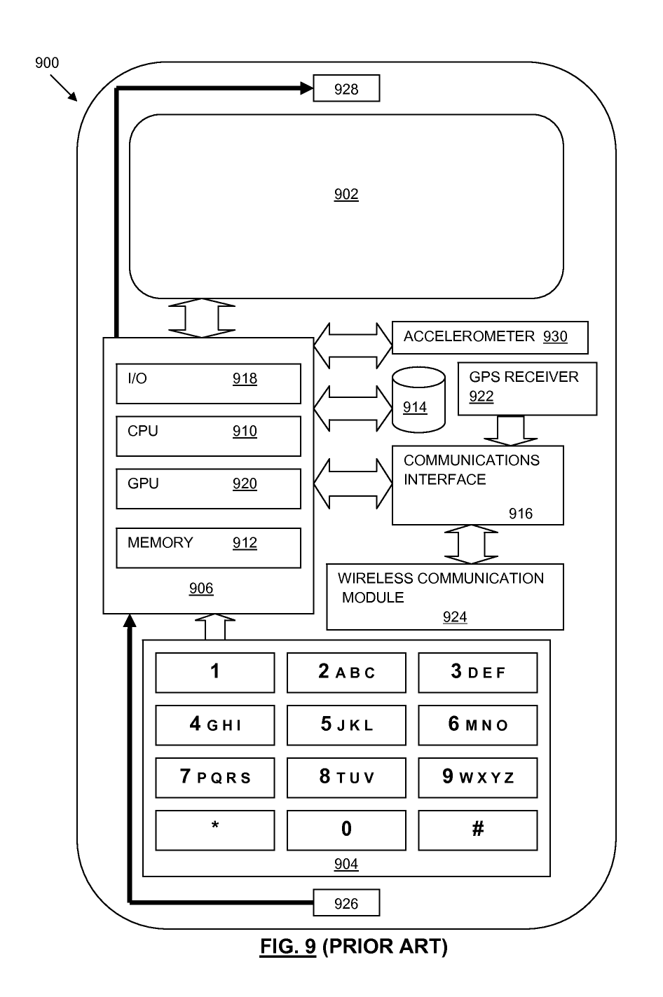

FIG. 9 shows an exemplary network-capable smartphone 900. The smartphone 900 includes a display 902, an input device in the form of keyboard 904 and an onboard computer system 906. The display 902 may be a touch-screen display and thereby serve as an additional input device, in which case the keyboard 904 may be omitted. The onboard computer system 906 comprises a central processing unit (CPU) 910 having one or more processors or microprocessors for performing arithmetic calculations and control functions to execute software stored in an internal memory 912, preferably random access memory (RAM) and/or read only memory (ROM) is coupled to additional memory 914 which will typically comprise flash memory, which may be integrated into the smartphone 900 or may comprise a removable flash card, or both. The smartphone 900 also includes a communications interface 916 which allows software and data to be transferred between the smartphone 900 and external systems and networks. The communications interface 916 is coupled to one or more wireless communication modules 924, which will typically comprise a wireless radio for connecting to one or more of a cellular network, a wireless digital network or a Wi-Fi network. The communications interface 916 will also typically enable a wired connection of the smartphone 900 to an external computer system. A microphone 926 and speaker 928 are coupled to the onboard computer system 906 to support the telephone functions managed by the onboard computer system 906, and GPS receiver hardware 922 is also coupled to the communications interface 916 to support navigation operations by the onboard computer system 906. An accelerometer 930 for detecting tilting and movement of the smartphone 900 is also coupled to the onboard computer system 906. Input and output to and from the onboard computer system 906 is administered by the input/output (I/O) interface 918, which administers control of the display 902, keyboard 904, microphone 926 and speaker 928. The onboard computer system 906 may also include a separate graphical processing unit (GPU) 920. The various components are coupled to one another either directly or by coupling to suitable buses.

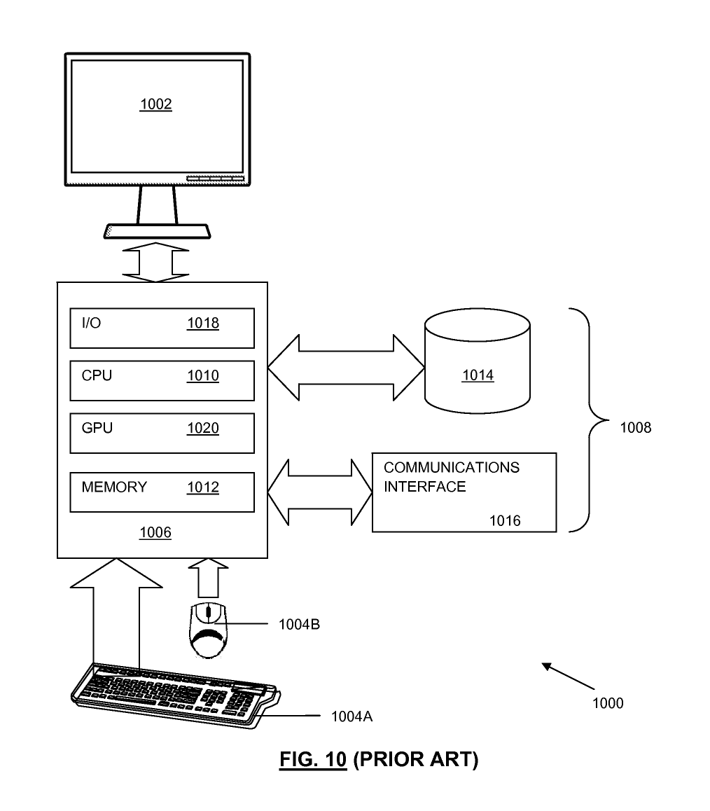

An illustrative computer system in respect of which aspects of the present invention may be implemented, for example as a controlling computing device or controllable computing device, is presented as a block diagram in FIG. 10. The illustrative computer system is denoted generally by reference numeral 1000 and includes a display 1002, input devices in the form of keyboard 1004A and pointing device 1004B, computer 1006 and external devices 1008. While pointing device 1004B is depicted as a mouse, it will be appreciated that other types of pointing device may also be used.

The computer 1006 may contain one or more processors or microprocessors, such as a central processing unit (CPU) 1010. The CPU 1010 performs arithmetic calculations and control functions to execute software stored in an internal memory 1012, preferably random access memory (RAM) and/or read only memory (ROM), and possibly additional memory 1014. The additional memory 1014 may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 1014 may be physically internal to the computer 1006, or external as shown in FIG. 10.

The computer system 1000 may also include other similar means for allowing computer programs or other instructions to be loaded. Such means can include, for example, a communications interface 1016 which allows software and data to be transferred between the computer system 1000 and external systems and networks. Examples of communications interface 1016 can include a modem, a network interface such as an Ethernet card, a wireless communication interface, or a serial or parallel communications port. Software and data transferred via communications interface 1016 are in the form of signals which can be electronic, acoustic, electromagnetic, optical or other signals capable of being received by communications interface 1016. Multiple interfaces, of course, can be provided on a single computer system 1000.

Input and output to and from the computer 1006 is administered by the input/output (I/O) interface 1018. This I/O interface 1018 administers control of the display 1002, keyboard 1004A, external devices 1008 and other such components of the computer system 1000. The computer 1006 also includes a graphical processing unit (GPU) 1020. The latter may also be used for computational purposes as an adjunct to, or instead of, the (CPU) 1010, for mathematical calculations.

The various components of the computer system 1000 are coupled to one another either directly or by coupling to suitable buses.

Embodiments of aspects of the present invention may be implemented entirely in hardware, entirely in software, or by way of a combination of hardware and software. In a preferred embodiment, the invention is implemented in software, which includes but is not limited to firmware, resident software, microcode, and the like. Furthermore, the invention can take the form of a computer program product accessible from a non-transitory computer usable or computer readable medium providing program code for use by or in connection with a computer or any instruction execution system. In such embodiments, the computer program product may reside on a computer usable or computer readable medium in a computer such as the memory 912 of the onboard computer system 906 of the smartphone 900 or the memory 1012 of the computer 1006, or on a computer usable or computer readable medium external to the onboard computer system 906 of the smartphone 900 or the computer 1006, or on any combination thereof.

Several currently preferred embodiments have been described by way of example. It will be apparent to persons skilled in the art that a number of variations and modifications can be made without departing from the scope of the invention as defined in the claims.

1-10. (canceled)

11. A method for defining a user interface for controlling, from a controlling computing device connected to a network, specified functionality of a controllable computing device connected to the network, the method comprising:
receiving control input comprising associations between actions on the controlling computing device and commands for controlling the specified functionality of the controllable computing device; and
storing the actions, associations and commands as part of the user interface.

12. The method of claim 11, wherein:
the controlling computing device is a touch-screen device; and
the actions on the controlling computing device comprise actuation of touch-actuable widgets;
the method further comprising:
receiving positional input defining a positional layout of the touch-actuable widgets on a screen of the touch-screen device; and
storing the positional layout as part of the user interface.

13. The method of claim 11, wherein:
the user interface is a modified user interface; and
receiving control input associating actions on the controlling computing device with commands associated with the specified functionality of the controllable computing device comprises modification of an original user interface.

14. The method of claim 11, wherein the user interface is a new user interface.

15. The method of claim 11, wherein:
the user interface is stored on a server accessible by a plurality of parties; and
the user interface is made available to at least some of the plurality of parties.

16. A method of making user interfaces available, comprising:
storing a library of predefined user interfaces; and
responsive to a request for a particular one of the user interfaces, transmitting that particular user interface to the requestor.

17. The method of claim 16, further comprising:
receiving additional user interfaces from third parties; and
adding the additional user interfaces to the library.

18. The method of claim 17, further comprising:
before adding the additional user interfaces to the library, validating the additional user interfaces; and
adding the additional user interfaces to the library only in response to successful validation of the additional user interfaces.

19. The method of claim 16, wherein the user interfaces enable control, from a controlling computing device connected to an interconnecting network, of specified functionality of a controllable computing device connected to the interconnecting network; and
responsive to the request for the particular user interface, the particular user interface is transmitted to the controlling computing device.

20. The method of claim 16, wherein the user interfaces are associated with different software applications.

21. The method of claim 16, wherein the user interfaces include a subset of different user interfaces associated with a single software application.

22. The method of claim 16, further comprising:
receiving a modified user interface;
the modified user interface comprising a modified version of the particular user interface transmitted in response to the request; and
adding the modified user interface to the plurality of predefined user interfaces.

23. A computer program product comprising a non-transitory computer usable medium embodying computer usable program code for defining a user interface for controlling, from a controlling computing device connected to an interconnecting network, specified functionality of a controllable computing device connected to the interconnecting network, the computer program product comprising:
computer usable program code for receiving control input comprising associations between actions on the controlling computing device and commands for controlling the specified functionality of the controllable computing device; and
computer usable program code for storing the actions, associations and commands as part of the user interface.

24. The computer program product of claim 23, wherein:
the controlling computing device is a touch-screen device; and
the actions on the controlling computing device comprise actuation of touch-actuable widgets;
the computer program product further comprising:
computer usable program code for receiving positional input defining a positional layout of the touch-actuable widgets on a screen of the touch-screen device; and
computer usable program code for storing the positional layout as part of the user interface.

25. The computer program product of claim 23, wherein:
the user interface is a modified user interface; and
the computer usable program code for receiving control input associating actions on the controlling computing device with commands associated with the specified functionality of the controllable computing device comprises computer usable program code for modifying an original user interface.

26. The computer program product of claim 23, wherein the computer usable program code for receiving control input associating actions on the controlling computing device with commands associated with the specified functionality of the controllable computing device comprises computer usable program code for creating a new user interface.

27. The computer program product of claim 23, further comprising:
computer usable program code for storing the user interface on a server accessible by a plurality of parties; and
computer usable program code for making the user interface available to at least some of the plurality of parties.

28. A computing device for defining a user interface for controlling, from a controlling computing device connected to an interconnecting network, specified functionality of a controllable computing device connected to the interconnecting network, comprising:
a memory for storing instructions;
a processing unit coupled to the memory for executing the instructions stored in the memory, wherein the instructions, when executed by the processing unit, cause the computing device to:
receive control input comprising associations between actions on the controlling computing device and commands for controlling the specified functionality of the controllable computing device; and
store the actions, associations and commands as part of the user interface.

29. The computing device of claim 28, wherein:
the controlling computing device is a touch-screen device; and
the actions on the controlling computing device comprise actuation of touch-actuable widgets; and
wherein the instructions, when executed by the processing unit, further cause the computing device to:
receive positional input defining a positional layout of the touch-actuable widgets on a screen of the touch-screen device; and
store the positional layout as part of the user interface.

30. The computing device of claim 28, wherein:
the user interface is a modified user interface; and
receiving control input associating actions on the controlling computing device with commands associated with the specified functionality of the controllable computing device comprises modification of an original user interface.

31. The computing device of claim 28, wherein the user interface is a new user interface.

32. The computing device of claim 28, wherein the instructions, when executed by the processing unit, further cause the computing device to:
store the user interface on a server accessible by a plurality of parties; and
make the user interface available to at least some of the plurality of parties.

33. A method of making user interfaces available, comprising:
storing a library of predefined user interfaces; and
responsive to a request for a particular one of the user interfaces, transmitting that particular user interface to the requestor.

34. The method of claim 33, further comprising:
receiving additional user interfaces from third parties; and
adding the additional user interfaces to the library.

35. The method of claim 47, further comprising:
before adding the additional user interfaces to the library, validating the additional user interfaces; and
adding the additional user interfaces to the library only in response to successful validation of the additional user interfaces.

36. The method of claim 33, wherein the user interfaces enable control, from a controlling computing device connected to an interconnecting network, of specified functionality of a controllable computing device connected to the interconnecting network; and
responsive to the request for the particular user interface, the particular user interface is transmitted to the controlling computing device.

37. The method of claim 33, wherein the user interfaces are associated with different software applications.

38. The method of claim 33, wherein the user interfaces include a subset of different user interfaces associated with a single software application.

39. The method of claim 33, further comprising:
receiving a modified user interface;
the modified user interface comprising a modified version of the particular user interface transmitted in response to the request; and
adding the modified user interface to the plurality of predefined user interfaces.

40. A computer program product comprising a non-transitory computer usable medium embodying computer usable program code for making user interfaces available, the computer program product comprising:
computer usable program code for storing a library of predefined user interfaces; and
computer usable program code for, responsive to a request for a particular one of the user interfaces, transmitting that particular user interface to the requestor.

41. The computer program product of claim 40, further comprising:
computer usable program code for receiving additional user interfaces from third parties; and
computer usable program code for adding the additional user interfaces to the library.

42. The computer program product of claim 40, further comprising:
computer usable program code for validating the additional user interfaces before adding the additional user interfaces to the library; and
computer usable program code for adding the additional user interfaces to the library only in response to successful validation of the additional user interfaces.

43. The computer program product of claim 40, wherein the user interfaces enable control, from a controlling computing device connected to an interconnecting network, of specified functionality of a controllable computing device connected to the interconnecting network, further comprising:
computer usable program code for, responsive to the request for the particular user interface, transmitting the particular user interface to the controlling computing device.

44. The computer program product of claim 40, wherein the user interfaces are associated with different software applications.

45. The computer program product of claim 40, wherein the user interfaces include a subset of different user interfaces associated with a single software application.

46. The computer program product of claim 40, further comprising:
computer usable program code for receiving a modified user interface;
the modified user interface comprising a modified version of the particular user interface transmitted in response to the request; and
computer usable program code for adding the modified user interface to the plurality of predefined user interfaces.

47. A user interface distribution server for making user interfaces available, comprising:
a memory for storing instructions;
a processing unit coupled to the memory for executing the instructions stored in the memory, wherein the instructions, when executed by the processing unit, cause the user interface distribution server to:
store a library of predefined user interfaces; and
responsive to a request for a particular one of the user interfaces, transmit that particular user interface to the requestor.

48. The user interface distribution server of claim 47, wherein the instructions, when executed by the processing unit, further cause the computing device to:
receive additional user interfaces from third parties; and
add the additional user interfaces to the library.

49. The user interface distribution server of claim 61, wherein the instructions, when executed by the processing unit, further cause the computing device to:
before adding the additional user interfaces to the library, validate the additional user interfaces; and
add the additional user interfaces to the library only in response to successful validation of the additional user interfaces.

50. The user interface distribution server of claim 47, wherein the user interfaces enable control, from a controlling computing device connected to an interconnecting network, of specified functionality of a controllable computing device connected to the interconnecting network; and
wherein the instructions, when executed by the processing unit, further cause the computing device to, responsive to the request for the particular user interface, transmit the particular user interface to the controlling computing device.

51. The user interface distribution server of claim 47, wherein the user interfaces are associated with different software applications.

52. The user interface distribution server of claim 47, wherein the user interfaces include a subset of different user interfaces associated with a single software application.

53. The user interface distribution server of claim 47, wherein the instructions, when executed by the processing unit, further cause the computing device to:
receive a modified user interface;
the modified user interface comprising a modified version of the particular user interface transmitted in response to the request; and
add the modified user interface to the plurality of predefined user interfaces.
